(19) United States
(12) Patent Application Publication
(10) Pub. No.: US 2026/0118199 A1
(43) Pub. Date: Apr. 30, 2026

(54) METHOD FOR CALIBRATING AN FSR SENSOR AND DEVICE FOR PERFORMING CARDIAC RESUSCITATION

(71) Applicant: INNOTAS AG, Tägerwilen (CH)

(72) Inventors: Donald Herbert Dussault, Tägerwilen (CH); Dominic Oliver Dussault, Tägerwilen (CH)

(73) Assignee: INNOTAS AG, Tägerwilen (CH)

(21) Appl. No.: 18/835,174

(22) PCT Filed: Jan. 31, 2023
(86) PCT No.: PCT/EP2023/052258

§ 371 Date: Aug. 1, 2024

(30) Foreign Application Priority Data
Feb. 2, 2022 (DE) 10 2022 102 387.7

(51) Int. Cl. G01L 25/00; A61H 31/00; G09B 23/28

(52) U.S. Cl. CPC G01L 25/00; A61H 31/005; G09B 23/288; A61H 2201/5061

(57) ABSTRACT

The invention relates to a method for calibrating an FSR sensor (10) for use in detecting forces in a device (100) for performing cardiac resuscitation, the FSR sensor (10) being subjected to a predefined reference force (F_{R}) and relieved thereof again, at least a maximum value (Rₘₐₓ) and a minimum value (Rₘᵢₙ) of a signal (R) generated by the FSR sensor (10) being detected during subjection and relief and being compared to predefined values, and the signals (R) of the maximum value (Rₘₐₓ) and the minimum value (Rₘᵢₙ) being adjusted to the predefined values through circuitry or software.

### BACKGROUND OF THE INVENTION

The invention relates to a method for calibrating an FSR sensor for use in detecting forces in a device for performing cardiac resuscitation. The method described achieves a particularly precise detection of forces exerted on a human body during cardiac resuscitation. Furthermore, the invention relates to a device for performing cardiac resuscitation using an FSR sensor calibrated as per the method according to the invention.

A device for assisting a user during cardiopulmonary resuscitation is known from DE 10 2015 006 540 A1. The known device is in the form of a mat, which can be placed on the chest of a person to be resuscitated and is flexible in some areas, and has a visual display unit, which makes it easier for the user to exert the necessary force and frequency during resuscitation. In the area where the user's hands will be placed, the device has an FSR sensor, which is used to detect the forces exerted by the user. A variety of such FSR sensors are further known from the prior art (for example, US 2006/0007172 A1 or U.S. Pat. No. 8,026,906 B2). In the context of the invention, an FSR sensor is understood to be a sandwich-like sensor with a layer provided with a coated, conductive ink, the electrical resistance of which changes or decreases when a force is applied, which can be translated into a corresponding voltage signal of the FSR sensor through circuitry, for example.

The use of such an FSR sensor in connection with the described device for performing resuscitation is therefore expedient not only because of design-related advantages, such as a relatively low weight, its flexibility, and its relatively low power consumption, but also because FSR sensors of this kind can be manufactured relatively inexpensively while providing sufficient precision or accuracy for the detection of forces, and the more inexpensively such devices can be produced, the greater the spread of the aforementioned device, for example as a component in first aid equipment in a motor vehicle.

A particular problem with such FSR sensors is the time-dependent change in their electrical resistance and thus in the forces detected. Although FSR sensors are usually tested by the manufacturer during production, i.e., statically subjected to a reference force or test force in order to check their actual signals with regard to predefined tolerance values, the FSR sensor is usually placed on a fixed base for this purpose and the actual signal is detected after a predefined waiting time. This is because physical effects cause the measurement signal to typically decrease or drift relatively strongly within the first tenths of a second of the subjection to the test force and the decrease in electrical resistance then weakens, meaning the signal remains at least approximately constant afterwards, i.e., after the waiting time has elapsed. With regard to the force that typically has to be exerted on the human body during cardiac resuscitation within about 0.3 s, the force exerted cannot be determined exactly or precisely with FSR sensors that calibrated in the usual manner, meaning the values determined are not suitable for providing a user with information about a force that may be too high or too low.

### SUMMARY OF THE INVENTION

The method according to the invention for calibrating an FSR sensor for use in detecting forces in a device for performing cardiac resuscitation having the features disclosed herein has the advantage that, in conjunction with the as-accurate-as-possible detection of forces during the subjection phase and a relief phase following the subjection phase, it allows use of FSR sensors that have been calibrated by the manufacturer with regard to an actual signal only, which was determined in the context of tests usually carried out against fixed surfaces with a predefined static test force.

The invention utilizes the realization that signals from FSR sensors not only differ from one another during a dynamic subjection phase but also during a subsequent relief phase. In other words, there are FSR sensors that may generate the same signals during the subjection phase but different signals during a subsequent relief phase. However, since the intended use is to correctly display forces applied to a ribcage by a user, not only the maximum forces which cause (correct) compression of the ribcage but also the minimum forces, which, in the best case, lead to a complete relief of the ribcage when the force is completely reduced (to zero), are essential, it is essential for the FSR sensors to be calibrated for a relief phase as well.

In light of this, the method according to the invention for calibrating an FSR sensor for use in detecting forces in a device for performing cardiac resuscitation therefore provides for the FSR sensor to be subjected to a predefined reference force and relieved thereof again, at least a maximum value and a minimum value of a signal generated by the FSR sensor being detected during subjection and relief and being compared to predefined values, and the signals of the maximum value and the minimum value being adjusted to the predefined values through circuitry or software.

Predefined values are understood to be signals that are expected at a specific force exerted on the FSR sensor.

Advantageous embodiments of the method according to the invention for calibrating an FSR sensor for use in detecting forces in a device for performing cardiac resuscitation are specified in the dependent claims.

As stated above, it is essential for the use of the FSR sensor in resuscitation that the forces detected by the FSR sensor are detected very quickly (within few tenths of a second) with high precision, subjection phases and relief phases typically alternating over a longer period of time during resuscitation. In order to enable the FSR sensor used in each case to be adapted to such an application, a further, particularly preferred method of calibration is provided in a first variant, in which repeated subjection to and relief of the reference force takes place during a predefined testing period, preferably at a frequency of 100 cycles of subjection and relief per minute, and the signals are adjusted based on a mean value of the signals during the testing period.

Alternatively, repeated subjection to and relief of the reference force may take place during a predefined testing period, preferably at a frequency of 100 cycles of subjection and relief per minute, and the signals may be adjusted based on signals detected last during the testing period.

With regard to the intended application for compressing a ribcage, it is also intended to simulate such an application by increasing or decreasing the reference force linearly or suddenly, the reference force preferably being reduced fully, i.e., to zero, when being decreased.

Moreover, it is preferred for a subjection phase of the FSR sensor to be immediately followed by a relief phase.

In the simplest case, the methods according to the invention described thus far take place using a stiff surface, which serves as a support for the FSR sensor and which is disposed on the side of the reference force to be applied facing away from the FSR sensor.

However, it is particularly preferred for the FSR sensor to rest on a flexible surface while being subjected to the reference force.

With regard to the intended area of application, it is particularly advantageous if the flexible surface is formed by a CPR dummy. Such a CPR dummy is usually defined by standards with regard to its specific design, i.e., with regard to its flexible behavior for imitating a human body or ribcage, and therefore offers the best option for adapting the FSR sensor to the real application as optimally as possible.

In connection with the use of a CPR dummy, it is particularly preferred for the reference force to be selected to the effect that the ribcage of the CPR dummy is compressed to a defined depth of compression, in particular 5 cm, during subjection.

Furthermore, the invention comprises a device for performing cardiac resuscitation using an FSR sensor calibrated according to a method described above. Such a device is in particular in the form of the device disclosed in DE 10 2015 006 540 A1, which is to be incorporated in this application in this respect.

Further advantages, features and details of the invention are apparent from the following description of preferred embodiments of the invention and from the drawings.

### BRIEF DESCRIPTION OF THE DRAWINGS

FIG. 1 shows a device for performing resuscitation in an application position on the chest area of a person;

FIG. 2 is a cross-section through the device according to FIG. 1 in the area of an FSR sensor;

FIG. 3a and FIG. 3b each show in a simplified illustration of different arrangements for performing a subjection test on an FSR sensor;

FIG. 4 is a diagram explaining different curves regarding the subjection and relief of a reference FSR sensor and a FSR sensor to be calibrated with a reference force; and

FIG. 5 is a diagram explaining the use of a device according to FIG. 1 in connection with signals of an FSR sensor.

### DETAILED DESCRIPTION

Identical elements or elements having the same function are provided with the same reference signs in the figures.

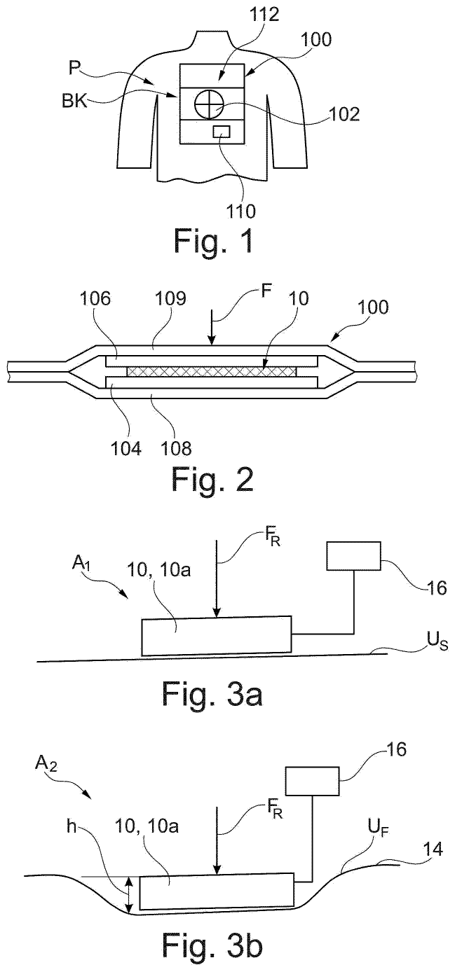

In a highly simplified manner, FIG. 1 shows a device 100 for performing resuscitation, in particular cardiopulmonary resuscitation. A device 100 of this type is known from applicants' DE 10 2015 006 540 A1, which is to be incorporated in this application in this respect. In particular, reference is made to the description of the functioning of such a device 100 and individual elements of the device 100 in the aforementioned document.

The device 100 has an area 102 in which the user is to exert force on the ribcage BK of the person P to be reanimated with the user's arms when the device 100 is placed on the ribcage BK in order to compress the person's P ribcage BK, thereby starting or supporting the person's P heart function. Typically, the ribcage BK is to be compressed by a distance or depth of compression h of 5 cm in a direction perpendicular to the plane of the device 100. The reanimation of the person P is carried out or supported by rhythmic subjection and relief of the device 100 in the area 102 with a frequency of also typically 100 cycles of subjection and relief per minute, as is known per se.

In area 102, between two plates 104, 106, which in turn are enclosed by two layers 108, 109 of the device 100, the device 100 has an FSR sensor 10, which is configured to detect the force F acting on it perpendicularly in the plane of the FSR sensor 10 and to supply it to a control device 110 of the device 100 as an input variable. The control device 110 of the device 100 detects the temporal development of the magnitude or height of the signal of the FSR sensor 10 with the result that, with regard to the above-mentioned measures for resuscitation and in connection with a user performing said measures, information is provided as to whether the user is performing the reanimation with the required (correct) force F and the required (correct) frequency f in the area of a display 112 (and possibly a corresponding acoustic actuator) of the user performing the measures.

FIG. 3a shows a first test arrangement A₁ for calibrating an FSR sensor 10 in a highly simplified manner. The first test arrangement A₁ has a stiff surface U_{S} on which the FSR sensor 10 rests. The FSR sensor 10 can be subjected to a reference force F_{R} which is perpendicular to the surface U_{S} and to the plane of the FSR sensor 10 and which is generated by a device not shown. An evaluation unit 16 receives and analyzes signals generated by the FSR sensor 10.

FIG. 3b shows a second test arrangement A₂ for calibrating an FSR sensor 10 in a highly simplified manner. The second test arrangement A₂ has a flexible surface U_{F} on which the FSR sensor 10 rests. The FSR sensor 10 can be subjected to a reference force F_{R} which is perpendicular to the surface U_{F} and to the plane of the FSR sensor 10. The flexible surface U_{F} can be a rubber or foam plate, for example. However, it is preferred fir the flexible surface U_{F} to be a CPR (cardio-pulmonary resuscitation) dummy 14. In this case, the CPR dummy 14 is compressed to a depth of compression h when subjected to the reference force F_{R}, the depth of compression h serving to simulate the compression of the ribcage BK. In particular, the reference force F_{R} is to be selected in such a manner that a depth of compression h of approx. 5 cm is achieved. This value corresponds to the value that should be aimed for as a guideline during resuscitation.

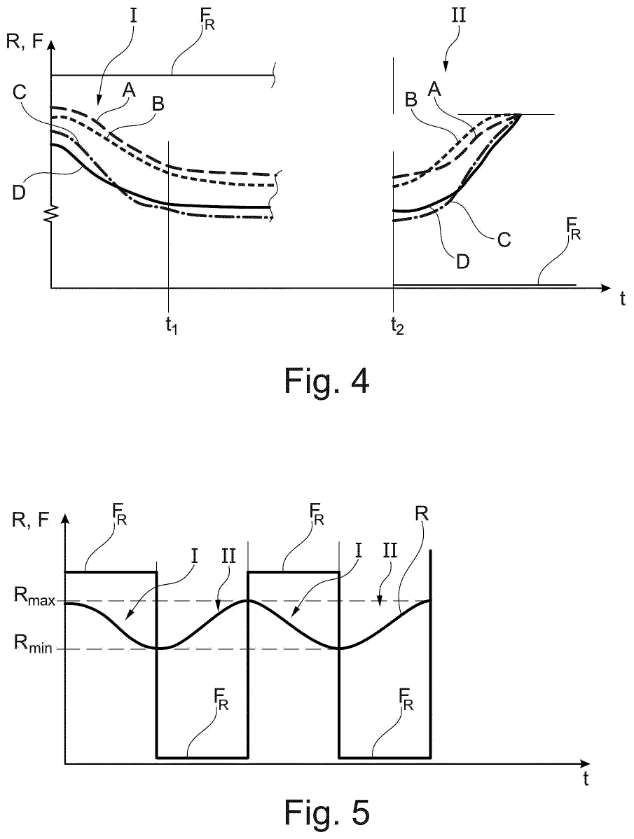

To ensure that the signals of the FSR sensor 10 detected by the control device 110 are detected with sufficient precision, reference is first made to the illustration of FIG. 4 below: FIG. 4 shows the electrical resistance R generated by two different FSR sensors 10, 10a when subjected to the reference force F_{R} over time with different curves A, B, C and D in a highly simplified manner. The electrical resistance R serves as an input variable for generating in particular a voltage signal representing the reference force F_{R}, as is known per se from the state of the art.

While curves A and B belong to FSR sensor 10a, which, for example, serves as a reference FSR sensor 10a when calibrating FSR sensors 10 at the manufacturing plant of the FSR sensors 10, curves C and D belong to an FSR sensor 10 which is to be calibrated and to be used in a device 100.

Furthermore, curves A and C for the FSR sensor 10, 10a are supposed to correspond to a test situation in which the FSR sensor 10, 10a is disposed on a stiff surface U_{S} in accordance with the first test arrangement A₁ as shown in FIG. 3a. In contrast, curves B and D represent the FSR sensor 10, 10a that is arranged on a flexible surface U_{F} according to the second test arrangement A₂ as shown in FIG. 3b.

FIG. 4 shows a subjection phase I and a relief phase II. During the subjection phase I, the FSR sensor 10, 10a is subjected to the reference force F_{R}. In contrast, the relief phase II is characterized by the fact that the reference force F_{R} is (again) reduced to zero.

With reference to FIG. 4, the basic behavior of an FSR sensor 10, 10a is explained to the effect that the resistance R generated during subjection to the reference force F_{R} initially decreases sharply during the subjection phase I and remains at least approximately constant from point in time t₁, which is typically reached after approx. 200 s. In particular, it is explained that the reduction in resistance R up to point in time t₁ can be up to approx. 10% (relative to the resistance R at point in time t=0, the resistance R already decreasing by up to 30 % of its total reduction within the first second.

Furthermore, it can be seen that due to the stiff surface U_{S}, curves A and C of the FSR sensors 10, 10a have higher resistance values R than curves B and D, where the FSR sensor 10, 10a is disposed on the flexible surface U_{F}. It can also be seen that the development of the increase in resistance R during the relief phase II, which starts at point in time t₂, can differ from the development during the subjection phase I, i.e., that the rates of change can differ from each other by up to 5 %, for example.

When the FSR sensor 10 is manufactured, the manufacturer compares its resistance R to the resistance of the reference sensor 10a in the first test arrangement A₁ at a point in time t at which no further significant change in resistance R occurs, i.e., as explained above, for example, from point in time t₁. The difference AR between the resistances R of the two FSR sensors 10, 10a is typically due to manufacturing tolerances. The manufacturer of the FSR sensor can compensate for the known difference AR in the FSR sensor 10, for example through circuitry by means of a series resistor or the like, or through software by means of a suitable algorithm if the FSR sensor 10 has its own evaluation logic, for example.

However, such an FSR sensor 10 is not suitable for use with device 100: The reason for this is that, in the case of a dynamic subjection of the FSR sensor 10, in which the reference force F_{R} changes between zero and a value which causes a compression of the ribcage BK by approx. 5 cm, in particular every approx. 0.6 s (corresponding to a frequency of 100 subjections per minute), curves C and D are in the period of time before point in time t₁ and after point in time t₂, i.e., they exhibit high rates of change. Furthermore, the effect of the flexible surface U_{F} or the CPR dummy 16 has not been taken into account by the manufacturer.

Hence, for the calibration of the FSR sensor 10 in connection with the use of the FSR sensor 10 in device 100, the invention provides a subjection test during a testing period with a subjection profile of the FSR sensor 10 in a first test arrangement A₁, in which the FSR sensor 10 is alternately subjected to the reference force F_{R} and fully relieved thereof every 0.6 s, as illustrated in FIG. 5. This results in directly consecutive subjection phases I and relief phases II. During the respective time intervals of approx. 0.6 s, the respective minimum resistance values Rₘᵢₙ and maximum resistance values Rₘₐₓ are detected as actual values of the FSR sensor 10. The reference force F_{R} is then assigned to the minimum resistance value Rₘᵢₙ, and the value of the force zero is assigned to the maximum resistance value Rₘₐₓ. For resistances R between the minimum resistance value Rₘᵢₙ and the maximum resistance value Rₘₐₓ, a linear interpolation is preferably carried out in order to assign the corresponding force values F to the respective resistances R. In this manner, the force-dependent characteristic curve of the FSR sensor 10 can be calibrated or generated.

If the calibration procedure described above is to be further improved, the subjection profile of the FSR sensor 10 described above can be carried out with a flexible surface U_{F} according to the second test arrangement A₂.

The calibration procedures described thus far can be modified or modified in a variety of ways without deviating from the spirit of the invention. For example, it is conceivable for curves C and D of the FSR sensor 10 according to FIG. 4 to be determined exactly, in particular in the periods of time t=0 to t₁ and from point in time t₂. The signals or resistance values R detected in the process can be corrected or adjusted taking into account the known resistance value R from point in time t₁, for any point in time t, with the result that the reference force F_{R} can also be determined exactly in the periods of time up to point in time t₁ or from point in time t₂ if a test in accordance with FIG. 5 is carried out.

### REFERENCE SIGNS

10 FSR sensor
14 CPR dummy
16 evaluation unit
100 device
102 area
104 plate
106 plate
108 layer
109 layer
110 control device
112 display
h depth of compression
t time
t₁, t₂ point in time
I subjection phase
II relief phase
A₁, A₂ test arrangement
U_{S} stiff surface
U_{F} flexible surface
BK ribcage
F force
F_{R} reference force
P person
A to D curve

1. A method for calibrating an FSR sensor (10) for use in detecting forces in a device (100) for performing cardiac resuscitation, the FSR sensor (10) being subjected to a predefined reference force (F_{R}) and relieved thereof again, at least a maximum value (Rₘₐₓ) and a minimum value (Rₘᵢₙ) of a signal (R) generated by the FSR sensor (10) being detected during subjection and relief and being compared to predefined values, and the signals (R) of the maximum value (Rₘₐₓ) and the minimum value (Rₘᵢₙ) being adjusted to the predefined values through circuitry or software,
wherein repeated subjection to and relief of the reference force (F_{R}) takes place during a predefined testing period, and the signals (R) are adjusted based on a mean value of the signals (R) during the testing period, or
repeated subjection to and relief of the reference force (F_{R}) takes place during a predefined testing period, and the signals (R) are adjusted based on signals (R) detected last during the testing period,
the FSR sensor (10) rests on a flexible surface (U_{F}) while being subjected to the reference force (F_{R}), a CPR dummy (14) is used as the flexible surface (U_{F}), and the reference force (F_{R}) is selected to the effect that the ribcage (BK) of the CPR dummy (14) is compressed to a defined depth of compression (h) during subjection.

2. The method according to claim 1, wherein the reference force (F_{R}) is increased or decreased linearly or suddenly, the reference force (F_{R}) preferably being reduced fully when being decreased.

3. The method according to claim 1, wherein a subjection phase (I) of the FSR sensor (10) to the reference force (F_{R}) is immediately followed by a relief phase (II).

4. A device (100) for performing cardiac resuscitation using an FSR sensor (10) calibrated according to claim 1.

5-10. (canceled)

11. The method according to claim 1, wherein the repeated subjection to and relief of the reference force (F_{R}) takes place at a frequency of 100 cycles of subjection and relief per minute.

12. The method according to claim 1, wherein the defined depth of compression (h) is 5 cm.
